(19) United States
(12) Patent Application Publication
(10) Pub. No.: US 2026/0340192 A1
(43) Pub. Date: Oct. 29, 2026

(54) ISOLATED SANDBOX INSIDE OF AN ISOLATED RECOVERY ENVIRONMENT (IRE)

(71) Applicant: International Business Machines Corporation, Armonk, NY (US)

(72) Inventors: Christopher J. Vollmar, Mississauga (CA); Fraser Iain Macintosh, Reading (GB); Erin M. Farr, Fishkill, NY (US); Juan Carlos Jimenez Fuentes, Forney, TX (US)

(21) Appl. No.: 19/189,156

(22) Filed: Apr. 24, 2025

(51) Int. Cl. G06F 21/64

(52) U.S. Cl. CPC G06F 21/64

(57) ABSTRACT

A method, according to one embodiment, comprises dynamically examining characteristics of a first workload associated with recovery from a data corruption attack, and programmatically building and deploying an isolated sandbox inside of an isolated recovery environment (IRE), where the isolated sandbox has a unidirectional data flow such that data that enters the isolated sandbox cannot leave the isolated sandbox. The method further comprises causing data associated with the first workload to enter the isolated sandbox, and determining, using the data associated with the first workload, while in the isolated sandbox, a recipe of remediation steps to return corrupted data of the first workload to a cleaned state. The method further comprises using the recipe, in a production environment of the first workload, to return the corrupted data to the cleaned state.

### BACKGROUND

The present invention relates to data, and more specifically, this invention relates to cybersecurity.

Cybersecurity involves the protection of computer systems and networks from attacks by malicious actors. Depending on the type(s) of computer systems and/or networks that are affected, a cybersecurity attack may result in unauthorized information disclosure, damage to hardware and/or software, corruption of data, etc.

While some platforms have been developed to protect computer systems and networks from such attacks, threats are consistently evolving. Computer systems and networks thereby face various types of attacks over time. Ransomware is one such type of cybersecurity attack that has been difficult for conventional products to detect and overcome.

### SUMMARY

A method, according to one embodiment, comprises dynamically examining characteristics of a first workload associated with recovery from a data corruption attack, and programmatically building and deploying an isolated sandbox inside of an isolated recovery environment (IRE), where the isolated sandbox has a unidirectional data flow such that data that enters the isolated sandbox cannot leave the isolated sandbox. The method further comprises causing data associated with the first workload to enter the isolated sandbox, and determining, using the data associated with the first workload, while in the isolated sandbox, a recipe of remediation steps to return corrupted data of the first workload to a cleaned state. The method further comprises using the recipe, in a production environment of the first workload, to return the corrupted data to the cleaned state.

A computer program product, according to another embodiment, comprises one or more computer-readable storage media, and program instructions stored on the one or more storage media to perform the foregoing method.

A computer system, according to another embodiment, comprises a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a flowchart of a method, in accordance with one embodiment of the present invention.

FIG. 4 is a flowchart of a method, in accordance with one embodiment of the present invention.

FIG. 5 is a diagram of a workflow environment, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for mitigating malicious harm in data of workloads in production environment(s).

In one general embodiment, a method comprises dynamically examining characteristics of a first workload associated with recovery from a data corruption attack, and programmatically building and deploying an isolated sandbox inside of an isolated recovery environment (IRE), where the isolated sandbox has a unidirectional data flow such that data that enters the isolated sandbox cannot leave the isolated sandbox. The method further comprises causing data associated with the first workload to enter the isolated sandbox, and determining, using the data associated with the first workload, while in the isolated sandbox, a recipe of remediation steps to return corrupted data of the first workload to a cleaned state. The method further comprises using the recipe, in a production environment of the first workload, to return the corrupted data to the cleaned state.

In another general embodiment, a computer program product comprises one or more computer-readable storage media, and program instructions stored on the one or more storage media to perform the foregoing method.

In another general embodiment, a computer system comprises a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as remediation step determination code of block 150 mitigating malicious harm in data of workloads in production environment(s). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

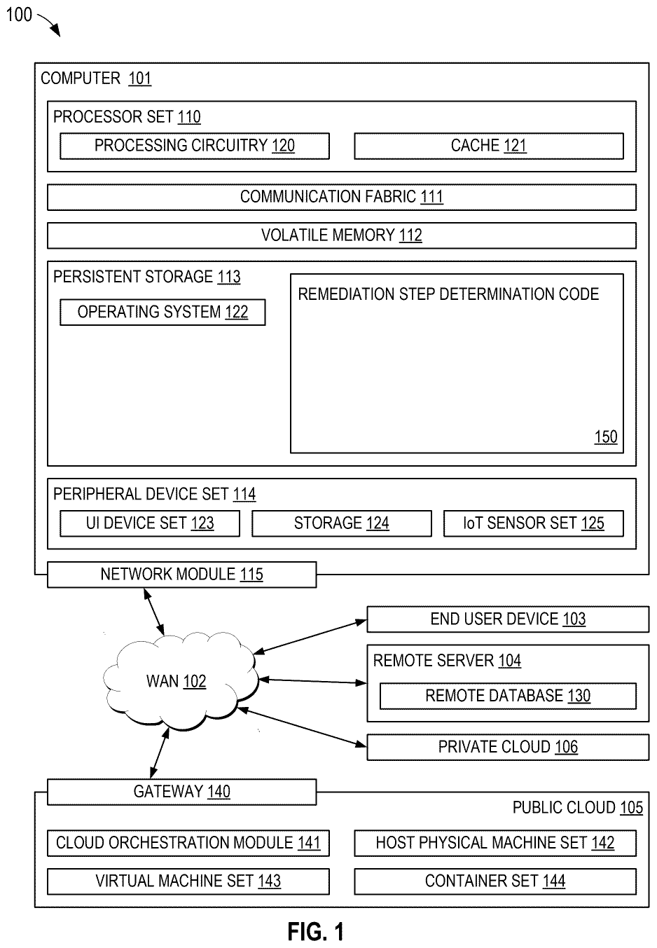

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, cybersecurity involves the protection of computer systems and networks from attacks by malicious actors. Depending on the type(s) of computer systems and/or networks that are affected, a cybersecurity attack may result in unauthorized information disclosure, damage to hardware and/or software, corruption of data, etc.

While some platforms have been developed to protect computer systems and networks from such attacks, threats are consistently evolving. Computer systems and networks thereby face various types of attacks over time. Ransomware is one such type of cybersecurity attack that has been difficult for conventional products to detect and overcome.

Ransomware and data corruption attacks force organizations to build out isolated sandboxes and/or isolated recovery environments (IRE) to test, validate and potentially confirm a way to recover data into a usable state for recovery. Speed of recovery of corrupted data is also becoming key, based on legislation such as the Digital Operational Resilience Act (DORA) and Network and Information Security 2 Directive (NIS2). Recovery Time Objectives (RTOs) are dramatically impacted by having to move data into and out of the isolated sandbox to test and validate. Another concern includes reintroducing dormant and/or active malware by recovering a workload back into production and then being re-infected in that environment and/or re-spreading the impact.

Embodiments and approaches described herein provide techniques to dynamically deploy (and/or preemptively deploy) an isolated sandbox testing environment to match impacted workloads, test data, record remediation steps, to thereby allow these remediation steps to be used as a recipe to clean the data ‘in place’. These techniques avoid a wait time that would otherwise be experienced as a result of moving data back and forth out of an isolated sandbox, and avoid operating cleaned production workloads from the isolated sandbox at potentially diminished capability. More specifically, these techniques include the ability to dynamically examine workload characteristics that need to be tested, validated, cleaned or prepared for recovery from a data corruption attack, which constitutes a “manifest”. Information about these characteristics is then leveraged to programmatically deploy an isolated sandbox inside an isolated recovery environment (IRE) to meet those characteristics (platform, operating system level, etc.). The remediation steps and tools to return the data to a clean state are identified and recorded as a “recipe” that is then used to clean the workloads where they exist in the production environment (rather than expending additional processing resources and time to move the cleaned data back into place).

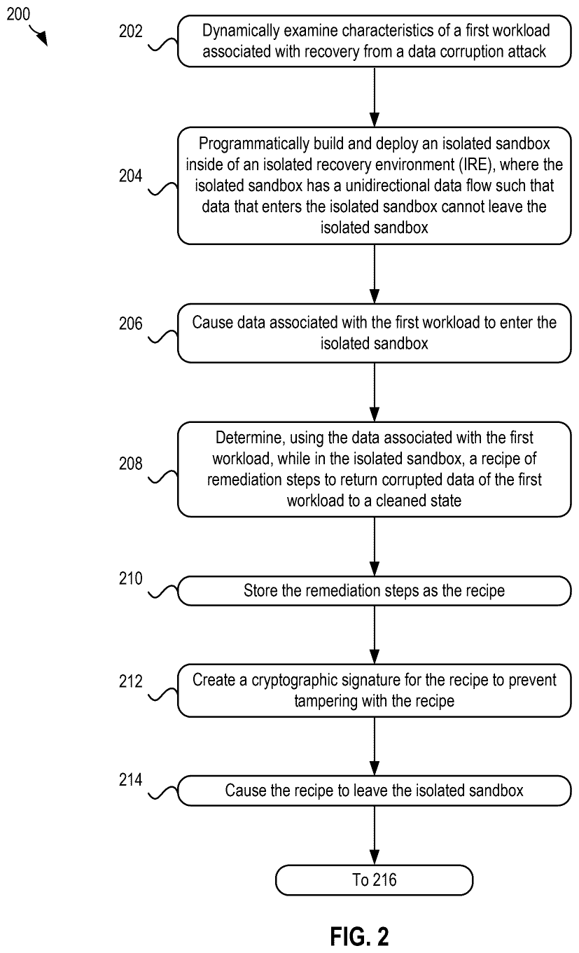

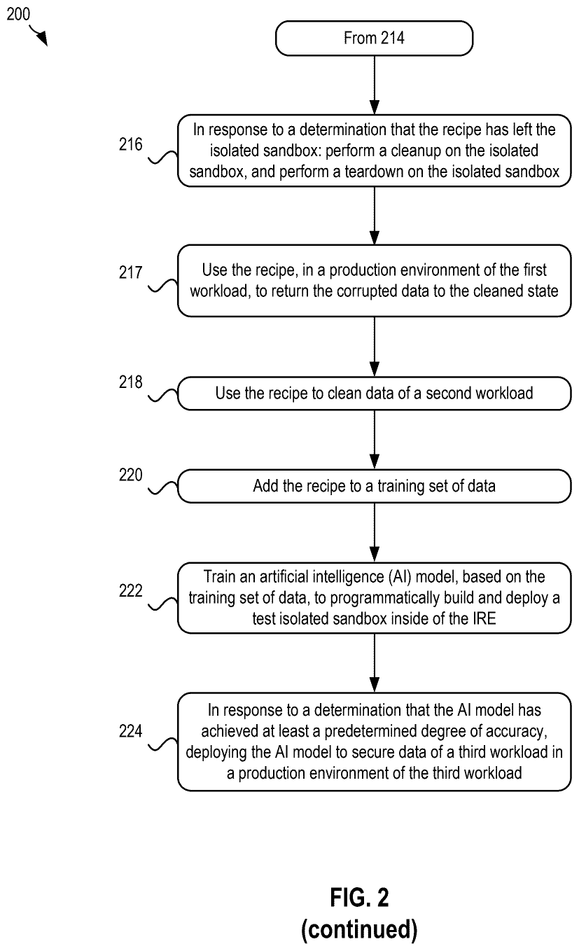

Now referring to FIG. 2, a flowchart of a method 200 is shown according to one embodiment. The method 200 may be performed in accordance with aspects of the present invention in any of the environments depicted in FIGS. 1-5, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes dynamically examining characteristics of a first workload associated with recovery from a data corruption attack. The data corruption attack may be of a type that would become apparent to one of ordinary skill in the art after reading the descriptions herein. For example, the data corruption attack may include, e.g., a phishing attack, access to the data by an unauthorized user device, a malware attack, a ransomware attack, a bombarding cybersecurity attack, etc. In other words, in some approaches, as a result of the data corruption attack occurring, the first workload and/or data associated therewith may need to be tested, validated, cleaned and/or prepared for cleaning in order to recover from the attack and/or as a precautionary measure (such as in cases in which it is unknown whether data of the workload is impacted by such an attack).

In some approaches, the characteristics of the first workload that are dynamically examined may include any type of characteristics that define an infrastructure in which the workload is performed and/or operating parameters associated with the workload. In one approach, the characteristics include specifications of a platform that the workload operates on. In yet another approach, the characteristics may additionally and/or alternatively include an operating system level that the workload is used with. In yet another approach, the characteristics may additionally and/or alternatively include indications of data associated with the workload that the data corruption attack may have impacted, e.g., modified. In such an approach, based on identification of such data, an infrastructure of hardware and/or software components used to perform a portion of the workload tasks that are specific to the data may be identified for determining components needed for building an isolated sandbox (as will be described in greater detail elsewhere below). In yet another approach, the characteristics may additionally and/or alternatively include performance metrics associated with processing the first workload, e.g., processing resources usage (of an infrastructure of hardware and/or software components used to perform the workload), processing resource availability, throughput of tasks of the first workload, etc. In some approaches, these performance metrics associated with processing the first workload may be based on requirements of the first workload, e.g., a chipset specification, networking specifications, memory specifications, performance specifications, processor type(s), OS, patch level, firmware settings, etc. In yet some other approaches, these requirements may additionally and/or alternatively be based on a number of VMs that are part of the workload and/or containers.

The dynamically examining the characteristics of the first workload associated with recovery from the data corruption attack may, in some approaches, include periodically evaluating the characteristics. In some other approaches, the dynamically examining the characteristics of the first workload associated with recovery from the data corruption attack may additionally and/or alternately include performing snapshots of sources that detail the characteristics and analyzing one or more of the snapshots in response to a determination that a data corruption attack has occurred and/or is relatively likely to occur.

In some other approaches, the characteristics of the first workload may include characteristics of infrastructure that were previously used in order for the data of the first workload to recover from the data corruption attack. Accordingly, these characteristics may be dynamically examined and identified by breaking down a log that details how such data was previously cleaned.

Operation 204 includes programmatically building and deploying an isolated sandbox inside of an IRE. For context, an isolated sandbox may, in some approaches, be defined as a secure computing environment in which data may be placed, but where the data is not accessible to user devices outside of the secure computing environment. More specifically, the isolated sandbox may be defined by a virtual and/or physical portion of the IRE. The IRE may, in some approaches, be defined as a secure infrastructure that is separate and independent from a production system. The hardware, software and/or other infrastructure that are caused, during building of the isolated sandbox, to make up the isolated sandbox and/or IRE are designed specifically for performing data recovery and generating remediation steps in the event of a cyberattack and/or system compromise event of a type that would become apparent to one of ordinary skill in the art after reading the descriptions herein. Furthermore, in preferred approaches, the isolated sandbox has a unidirectional data flow such that data that enters the isolated sandbox cannot leave the isolated sandbox. Data that has been examined may, in some approaches, be deleted or stored in the isolated sandbox, but not sent outbound from the isolated sandbox. More specifically, the isolated sandbox is designed to allow one way traffic of impacted data (data impacted by a cyberattack and/or system compromise event), such that data can enter into the isolated sandbox for testing but is not allowed to leave the isolated sandbox. More specifically, workload and/or production data may enter into the isolated sandbox for testing, but this data is not allowed to leave. Instead, only the recipe, that may be generated using, but does not include the workload and/or production data, is sent outbound of the isolated sandbox.

Techniques for moving the recovery recipe out of the isolated sandbox, in some approaches, need to be of a secure nature, which is not susceptible to the kinds of attacks which would allow for corruption of the recipe or re-infection/re-corruption of the data which has itself been cleaned. These techniques, therefore, in some approaches, may include (but not be limited to) machine-to-machine messaging, where an encrypted, authenticated communication channel can be used to move the recipe and/or its component instructions/functions out of the isolated sandbox; secure email systems; messaging applications such as MQ by INTERNATIONAL BUSINESS MACHINES CORPORATION (IBM); proprietary protocols; etc. Some further approaches may additionally and/or alternatively include displaying on-screen encoded information (accessible via mobile phone camera app for example), or printed pages with the information encoded into them, such as but not limited to QR codes, barcodes, etc. In preferred approaches, these techniques for transferring the recipe out of the IRE/isolated sandbox include cryptographic signatures so as to alert the user devices using them to instances of tampering.

In some approaches, a result of the dynamic examination of the characteristics of the first workload includes information about the examined characteristics. More specifically, in some approaches, the information about the examined characteristics may detail virtual and/or physical components to include as resources in the isolated sandbox. For example, the information is, in some approaches, used during the programmatic building to cause the isolated sandbox to satisfy the examined characteristics according to a platform and/or operating system level. In such an example, the platform and/or operating system level that the isolated sandbox is built to may match have parameters that are identified within characteristics extracted from metadata about the first workload and/or data associated with the first workload.

Once deployed, data associated with the first workload may be caused to enter the isolated sandbox, e.g., see operation 206. The data may be caused to enter the isolated sandbox by instructing an agent and/or bot to programmatically feed the data associated with the first workload into the isolated sandbox. In some other approaches, the data may additionally and/or alternatively be caused to automatically enter the isolated sandbox once generated based on the data being output from an engine. For example, data entering the isolated sandbox may be output from an engine that manages recovery from events. More specifically, in some approaches, after being recovered from backups and/or restored primary storage snapshots (more generally sometimes referred to as recovery points”), the data may be delivered to the isolated sandbox. In some approaches, the data associated with the first workload includes an entire dataset. In some other preferred approaches, the data associated with the first workload includes a portion of a dataset, e.g., chunks and/or files of data presumed to be impacted by the a cyberattack and/or system compromise event.

Operation 208 includes determining, using the data associated with the first workload, while in the isolated sandbox, a recipe of remediation steps to return corrupted data of the first workload to a cleaned state. Techniques for testing, cleaning, determining remediation steps and performing validation of the data set may be of a type that would become apparent to one of ordinary skill in the art after reading the descriptions herein. These techniques are performed within the isolated sandbox without any of the data leaving the isolated sandbox. In some approaches, these techniques include evaluation of snapshots taken before and/or after the data corruption attack. This evaluation may be used to characterize the data corruption attack by identifying, within the snapshots, an origin of impact of the data corruption attack within the data, and identifying spread of the attack throughout the data. This data may be incorporated, as a first remediation step, into forecasting algorithms of a trained artificial intelligence (AI) model to thereafter detect a similar attack. Techniques for determining remediation steps may additionally and/or alternatively include running simulations of executing different remediation steps on the data to identify a plurality of effective remediation steps. These remediation steps serve as a structure that creates a recipe for recovery.

Operation 210 includes storing the remediation steps as the recipe. In some approaches, the remediation steps are stored within the IRE and/or the isolated sandbox. It should be noted however, that prior to causing the recipe to leave the isolated sandbox, in some approaches, method 200 includes creating a cryptographic signature for the recipe to prevent tampering with the recipe, e.g., see operation 212. In other words, the cryptographic signature is created before the recipe is caused to leave the isolated sandbox. The cryptographic signature, in some approaches, incorporates encryption keys that are generated within the isolated sandbox. Other encryption and/or cryptographic techniques of a type that would become apparent to one of ordinary skill in the art after reading the descriptions herein may additionally and/or alternatively be used.

Operation 214 includes causing the recipe to leave the isolated sandbox, e.g., instructing an agent to pass the recipe out of the isolated sandbox.

Causing the recipe to leave the isolated sandbox, in some approaches, enables the recipe to be used, in a production environment of the first workload, to return the corrupted data to the cleaned state, e.g., see operation 217. For example, in some approaches, the returning the corrupted data to the cleaned state comprises removing dormant malware from the data associated with the first workload and/or recovering uncorrupted data from a backup source. It should be noted that the using the recipe to return the corrupted data to the cleaned state comprises not moving the data associated with the first workload from the isolated sandbox.

In some approaches, causing the recipe to leave the isolated sandbox additionally and/or alternatively enables the recipe to be used to clean data of a second workload (see operation 218), e.g., where the second workload is determined to have experienced a data corruption attack having at least a predetermined degree of similarity with the data of the first workload. For example, for some approaches in which the characteristics of the first workload include characteristics of infrastructure that were previously used in order for the data of the first workload to recover from the data corruption attack, the recipe is generated (based on historical analysis) as a remedy for the data of the second workload. In contrast, in some other approaches, the data of the first workload may additionally and/or alternatively in a compromised state (from the data corruption attack) at a time that the recipe leaves the isolated sandbox. Accordingly, the data of the first workload may additionally and/or alternatively be cleaned using the recipe. The data of these workloads are, in some approaches, cleaned where the workloads exist in a production environment. For example, in one or more of such approaches, the recipe is used to clean the data of the second workload at a location where the data of the second workload exists in a production environment.

It should be noted that a result of using the recipe to clean the data of the second workload includes the data of the second workload being returned to a state that existed before a cybersecurity event corrupted the data of the second workload. Similarly, in approaches in which the recipe is used to clean the data of the first workload at a location where the data of the first workload exists in a production environment, the result of using the recipe to clean the data of the first workload includes the data of the first workload being returned to a state that existed before the cybersecurity event corrupted the data of the workload. Recovery from the attacks described herein reduces latency and error in the technical field of computer infrastructure by mitigating malicious harm in data of workloads in production environment(s).

Similar to use of the recipe for the data of the first workload, it should be emphasized that using the recipe to clean the data of the second workload comprises not moving the data associated with the first workload from the isolated sandbox (the data cleaned in the isolated sandbox is not moved in the cleaned state back into the production environment). By not moving the data out of the isolated sandbox, a processing load that would otherwise be incurred in transferring data yet again is reduced.

In response to a determination that the recipe has left the isolated sandbox, in some approaches, method 200 includes performing a cleanup on the isolated sandbox, and/or performing a teardown on the isolated sandbox, e.g., see operation 216. In some approaches, this cleanup and/or teardown may include deleting data that exists within the isolated sandbox (to prevent the data from leaving the isolated sandbox).

Operation 220 includes adding the recipe to a training set of data. For context, the recipe may be added to the training set of data in order to incorporate use of AI into the process of mitigating malicious harm in data of workloads in production environment(s). For example, method 200, in some approaches, include training an AI model, based on the training set of data, to programmatically build and deploy a test isolated sandbox inside of the IRE, e.g., see operation 222. This way, the operations of method 200 may be, based on the training, performed by an AI model that is trained using the predetermined training set of data. For example, in some approaches, various of the operations noted above may be deployed in a trained state of a trained AI model. Training of the AI model, in some approaches, may be performed by applying a predetermined training data set to learn how to analyse characteristics of workflows, generate isolated sandboxes, etc. Initial training may include reward feedback that may, in some approaches, be implemented using a subject matter expert (SME). However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 200 may be performed. For example, in response to a determination that the AI model has achieved at least a predetermined degree of accuracy, the AI model is deployed to secure data of a third workload in a production environment of the third workload, e.g., see operation 224. In some further approaches, the AI model may be a neuromyotonic AI model that may improve performance of computer devices in an infrastructure associated with the production environment and/or the IRE, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from user devices that use the recipes described herein. Such an AI model ensures that malicious harm in data of workloads in production environment(s) is mitigated, where the scale of such analysis and determinations to achieve this benefit would not otherwise be feasible for a human to perform. This is because humans are not able to efficiently process data in an isolated sandbox of an IRE, and would otherwise incorporate processing delays and errors in the data cleaning process while attempting to do so. Accordingly, management of operations described herein is not able to be achieved by human manual actions.

The techniques of method 200 enable speed of validation and recovery where platforms may be dynamically provisioned as needed and/or where needed with no need to move data out of the isolated sandbox (this enables the recipe to be moved to the data to recover relatively faster).

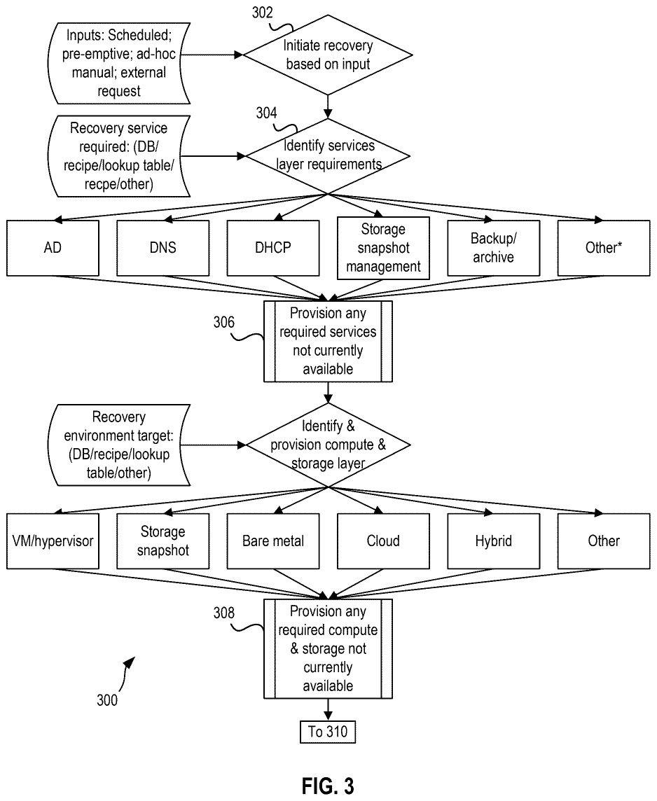

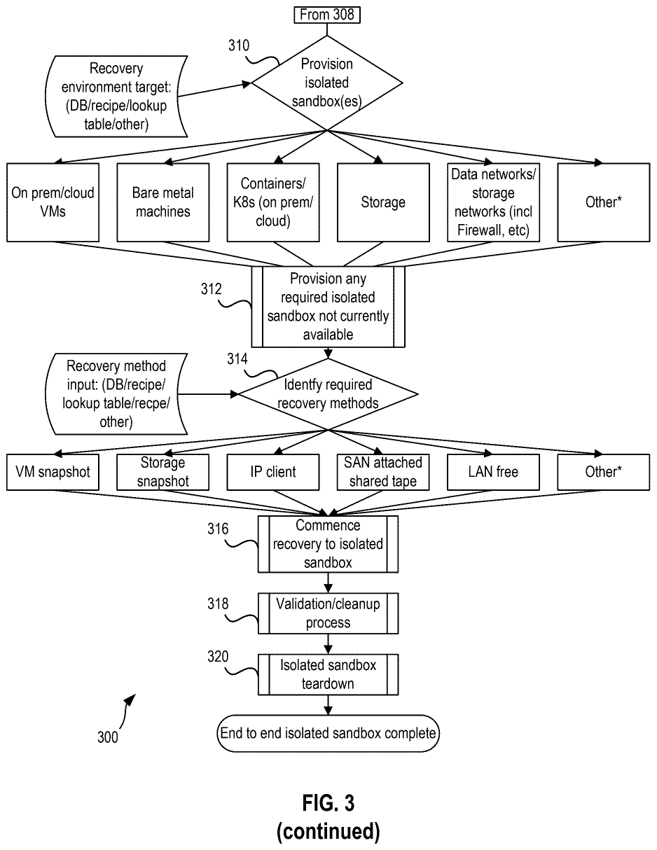

Now referring to FIG. 3, a flowchart of a method 300 is shown according to one embodiment. The method 300 may be performed in accordance with aspects of the present invention in any of the environments depicted in FIGS. 1-5, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 details techniques similar to some operations of method 200, and may similarly be used for mitigating malicious harm in data of workloads in production environment(s).

In some approaches, method 300 is performed in response to a data corruption attack and/or to prevent a data corruption attack. Accordingly, method 300, in some approaches, includes dynamically examining characteristics of a first workload associated with recovery from a data corruption attack. For example, inputs and be considered (see operation 302) and service layer requirements may be identified (see operation 304). Examples of these service layer requirements may include active directories (see AD), Domain Name Systems (see DNS), backup databases (see backup/archive), etc. Any resources that are needed for an isolated sandbox that are not available may be provisioned using techniques that would become apparent to one of ordinary skill in the art after reading the descriptions herein, e.g., see operation 306.

Method 300, in some approaches, includes identifying (e.g., based on a recovery environment target) and provisioning compute and storage layers in order to build an isolated sandbox within an IRE. For example, these compute and storage layers may include bare metal servers (e.g., see bare metal), cloud resources (e.g., see cloud), among other resources. Similar to the resources described above, in response to a determination that any required compute and storage layers are not currently available, they may be provisioned using techniques that would become apparent to one of ordinary skill in the art after reading the descriptions herein, e.g., see operation 308.

Operation 310 includes programmatically building and deploying an isolated sandbox inside of an IRE, which in the current approach includes a plurality of the provisioned and available resources, e.g., see storage, bare metal machines, containers, etc. In some approaches, the building of the isolated sandbox may include provisioning one or more existing isolated sandboxes, e.g., see operation 312.

Data associated with the first workload is caused to enter the isolated sandbox, and while in the isolated sandbox, a recipe of remediation steps to return corrupted data of the first workload to a cleaned state is determined (using the data associated with the first workload), e.g., see operation 314, operation 316 and recovery method input (which includes test cases for trial and error testing of different potential remediation steps).

In some approaches, the remediation steps are saved as a recipe, and once taken out of the isolated sandbox, are applied in a validation/cleanup process of data of one or more workloads, e.g., see operation 318. In response to a determination that the recipe has left the isolated sandbox, a cleanup on the isolated sandbox and a teardown on the isolated sandbox may be performed, e.g., see operation 320. This way, the isolated sandbox is composable and deployable (in a next different generated isolated sandbox). More specifically, the isolated sandbox is a dynamically composable (or scheduled pre-deploy) isolated recovery environment that uses a workload manifest to outline the workloads that need to be tested ‘as needed’ and automate the creating of the cleanroom platform based on that workload manifest. The solution to recovery, in some approaches, relies on workload description and/or discovery tooling to create the manifest and includes things such as/not limited to process platform, OS, bare metal/virtual, legacy/traditional/containerized, application listings, and associated types of storage requirements (Block/File/Object) and external services (AD/DNS). Moreover, the isolated sandbox is preferably able to be deployed anywhere as needed, e.g., such as on premises and/or cloud and/or private use cases.

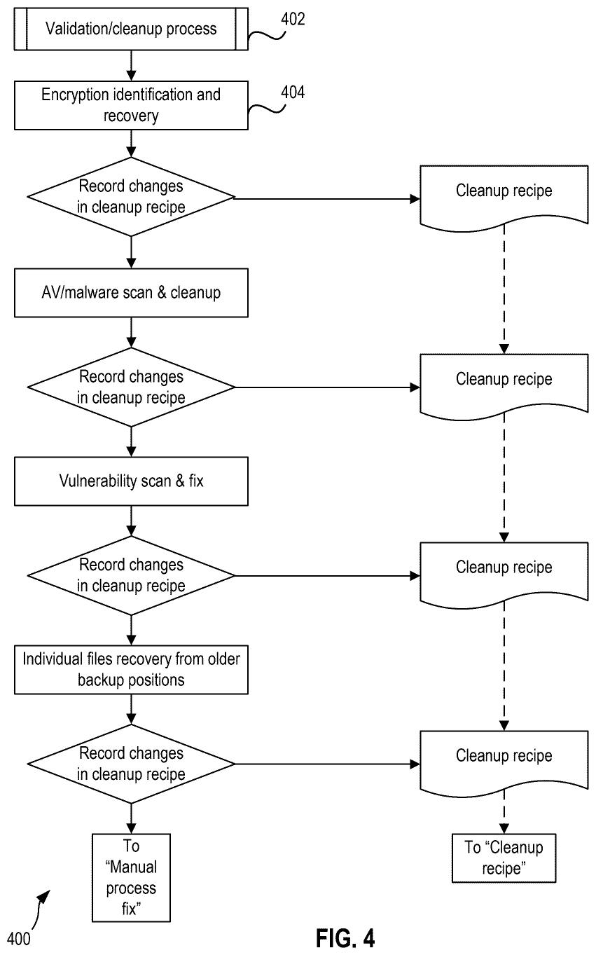

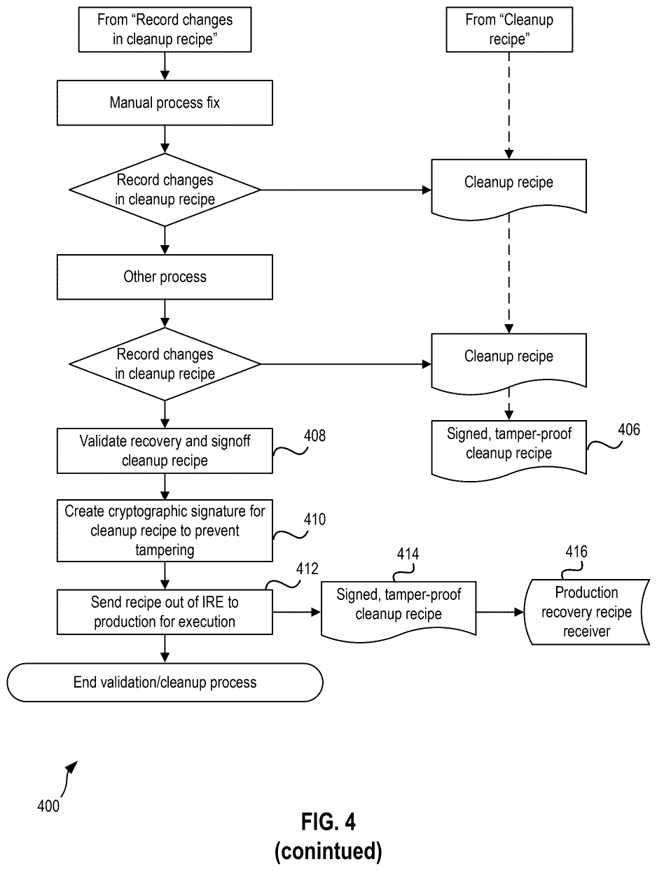

Now referring to FIG. 4, a flowchart of a method 400 is shown according to one embodiment. The method 400 may be performed in accordance with aspects of the present invention in any of the environments depicted in FIGS. 1-5, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 400 further defines techniques of operation(s) of method 300. More specifically, operations of method 400 detail the validation/cleanup process of operation 318 of method 300 described herein.

A validation/cleanup process of data of one or more workloads may be initially performed within an isolated sandbox to determine tweaks for the recipe, e.g., see operation 402. During generation of the recipe (before the recipe is caused to leave the isolated sandbox) a cryptographic signature may be created for the recipe to prevent tampering with the recipe, e.g., see operation 404.

Method 400 additionally, in some approaches, refinement of the recipe by generating different remediation steps. For example, in response to determining remediation steps based on malware, e.g., AV/malware scan & cleanup, a remediation step that, when executed, enacts the malware-based mitigation remediation step, may be added to the recipe, e.g., see arrow of Record changes in cleanup recipe lead to “Cleanup recipe”. Several of these additions of remediation steps to the recipe continue throughout logic of method 400. For example, in response to determining remediation steps based on a vulnerability scan performed on the data in the isolated sandbox, e.g., see vulnerability scan and fix, a remediation step that, when executed, enacts the scan results, may be added to the recipe, e.g., see arrow of Record changes in cleanup recipe lead to “Cleanup recipe”. A result of the additions includes the completed recipe 406.

Operation 408 includes performing a final validation of the recipe before causing the recipe to leave the isolated sandbox. Furthermore, the created cryptographic signature may be enacted before the recipe leaves the isolated sandbox, e.g., see operation 410. The recipe, once outside of the isolated sandbox, may be sent to a production environment for execution, e.g., see operation 412 that outputs the recipe 414 to a receiver device 416. Once the recipe is sent out and executed, the isolated sandbox may be broken down (though the data does not leave the isolated sandbox), e.g., see End validation/cleanup process. This way, the isolated sandbox enacts one way traffic of impacted data (data can go into the isolated sandbox for test but does not come out). The isolated sandbox thereby is used for testing, cleaning, remediation and validation of a data set, and the structure of the isolated sandbox thereby creates a recipe for recovery. The recipe is then used in ‘production’ to remediate the corrupted data, and can be used to automate a ‘proven’way to recover workload(s).

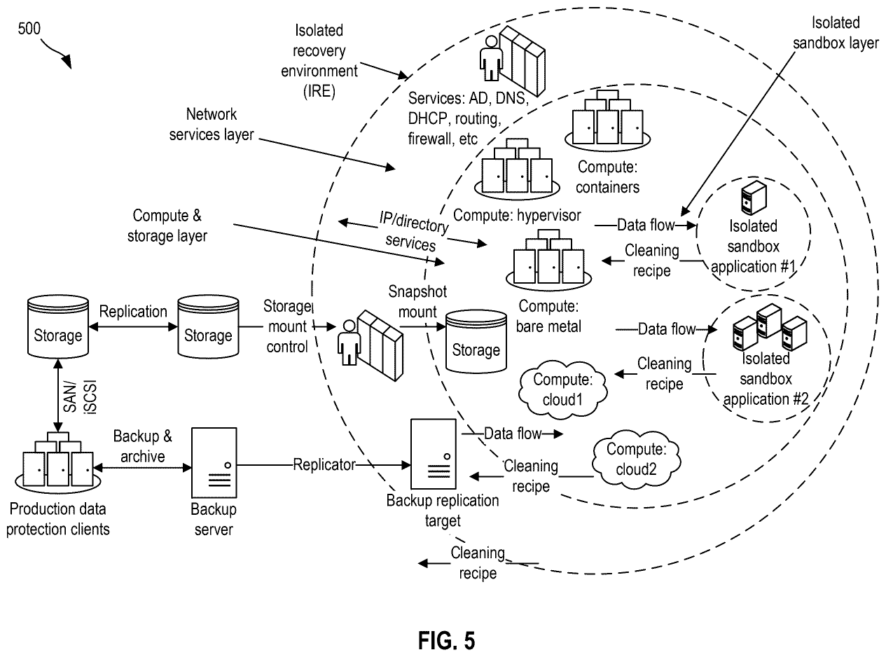

FIG. 5 depicts a workflow environment 500, in accordance with one embodiment. As an option, the present workflow environment 500 may be implemented in conjunction with features from any other embodiment listed herein, such as those described with reference to the other FIGS. Of course, however, such workflow environment 500 and others presented herein may be used in various applications and/or in permutations which may or may not be specifically described in the illustrative embodiments listed herein. Further, the workflow environment 500 presented herein may be used in any desired environment.

The workflow environment 500 includes an IRE that contains several layers of isolated sandboxes. More specifically, a first layer of the IRE includes a network services layer with associated service resources. A deeper virtual layer of the IRE includes a computer and storage layer with two isolated sandbox applications, e.g., see isolated sandbox application #1 and isolated sandbox application #2. The computer and storage layer includes a plurality of provisioned resources, e.g., see storage, bare metal, etc. Data may be added to this layer of the IRE, but cannot leave the IRE. A recipe with remediation steps to return corrupted data of a workload to a cleaned state is the only thing allowed to leave the isolated sandbox, e.g., see Cleaning recipe.

Outside of the layers of the IRE, the workflow environment 500 includes resources of a production environment, e.g., see storage, backup server, production data protection clients, etc. Note that the configurations and/or resources of the workflow environment 500 may differ in different approaches.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
dynamically examining characteristics of a first workload associated with recovery from a data corruption attack;
programmatically building and deploying an isolated sandbox inside of an isolated recovery environment (IRE),
wherein the isolated sandbox has a unidirectional data flow such that data that enters the isolated sandbox cannot leave the isolated sandbox;
causing data associated with the first workload to enter the isolated sandbox;
determining, using the data associated with the first workload, while in the isolated sandbox, a recipe of remediation steps to return corrupted data of the first workload to a cleaned state; and
using the recipe, in a production environment of the first workload, to return the corrupted data to the cleaned state.

2. The method of claim 1, wherein the using the recipe to return the corrupted data to the cleaned state comprises: not moving the data associated with the first workload from the isolated sandbox, wherein the returning the corrupted data to the cleaned state comprises: removing dormant malware from the data associated with the first workload and/or recovering uncorrupted data from a backup source.

3. The method of claim 1, further comprising:
storing the remediation steps as the recipe;
causing the recipe to leave the isolated sandbox; and
in response to a determination that the recipe has left the isolated sandbox: performing a cleanup on the isolated sandbox, and performing a teardown on the isolated sandbox.

4. The method of claim 1, further comprising:
creating a cryptographic signature for the recipe to prevent tampering with the recipe,
wherein the cryptographic signature is created before the recipe is caused to leave the isolated sandbox.

5. The method of claim 1, wherein a result of the dynamic examination of the characteristics of the first workload includes information about the examined characteristics, wherein the information is used during the programmatic building to cause the isolated sandbox to satisfy the examined characteristics according to a platform and/or operating system level.

6. The method of claim 1, further comprising:
using the recipe to clean data of a second workload,
wherein the recipe is used to clean the data of the second workload at a location where the data of the second workload exists in a production environment of the second workload.

7. The method of claim 6, wherein a result of using the recipe to clean the data of the second workload includes the data of the second workload being returned to a state that existed before a cybersecurity event corrupted the data of the second workload.

8. The method of claim 1, further comprising:
adding the recipe to a training set of data;
training an artificial intelligence (AI) model, based on the training set of data, to programmatically build and deploy a test isolated sandbox inside of the IRE; and
in response to a determination that the AI model has achieved at least a predetermined degree of accuracy, deploying the AI model to secure data of a third workload in a production environment of the third workload.

9. A computer program product comprising:
one or more computer-readable storage media; and
program instructions stored on the one or more storage media to perform operations comprising:
dynamically examining characteristics of a first workload associated with recovery from a data corruption attack;
programmatically building and deploying an isolated sandbox inside of an isolated recovery environment (IRE),
wherein the isolated sandbox has a unidirectional data flow such that data that enters the isolated sandbox cannot leave the isolated sandbox;
causing data associated with the first workload to enter the isolated sandbox;
determining, using the data associated with the first workload, while in the isolated sandbox, a recipe of remediation steps to return corrupted data of the first workload to a cleaned state; and
using the recipe, in a production environment of the first workload, to return the corrupted data to the cleaned state.

10. The computer program product of claim 9, wherein the using the recipe to return the corrupted data to the cleaned state comprises: not moving the data associated with the first workload from the isolated sandbox, wherein the returning the corrupted data to the cleaned state comprises: removing dormant malware from the data associated with the first workload and/or recovering uncorrupted data from a backup source.

11. The computer program product of claim 9, wherein the operations further comprise:
storing the remediation steps as the recipe;
causing the recipe to leave the isolated sandbox; and
in response to a determination that the recipe has left the isolated sandbox: performing a cleanup on the isolated sandbox, and performing a teardown on the isolated sandbox.

12. The computer program product of claim 9, wherein the operations further comprise:
creating a cryptographic signature for the recipe to prevent tampering with the recipe,
wherein the cryptographic signature is created before the recipe is caused to leave the isolated sandbox.

13. The computer program product of claim 9, wherein a result of the dynamic examination of the characteristics of the first workload includes information about the examined characteristics, wherein the information is used during the programmatic building to cause the isolated sandbox to satisfy the examined characteristics according to a platform and/or operating system level.

14. The computer program product of claim 9, wherein the operations further comprise:
using the recipe to clean data of a second workload,
wherein the recipe is used to clean the data of the second workload at a location where the data of the second workload exists in a production environment of the second workload.

15. The computer program product of claim 14, wherein a result of using the recipe to clean the data of the second workload includes the data of the second workload being returned to a state that existed before a cybersecurity event corrupted the data of the second workload.

16. The computer program product of claim 9, wherein the operations further comprise:
adding the recipe to a training set of data;
training an artificial intelligence (AI) model, based on the training set of data, to programmatically build and deploy a test isolated sandbox inside of the IRE; and
in response to a determination that the AI model has achieved at least a predetermined degree of accuracy, deploying the AI model to secure data of a third workload in a production environment of the third workload.

17. A computer system comprising:
a processor set;
one or more computer-readable storage media; and
program instructions stored on the one or more storage media to cause the processor set to perform operations comprising:
dynamically examining characteristics of a first workload associated with recovery from a data corruption attack;
programmatically building and deploying an isolated sandbox inside of an isolated recovery environment (IRE),
wherein the isolated sandbox has a unidirectional data flow such that data that enters the isolated sandbox cannot leave the isolated sandbox;
causing data associated with the first workload to enter the isolated sandbox;
determining, using the data associated with the first workload, while in the isolated sandbox, a recipe of remediation steps to return corrupted data of the first workload to a cleaned state; and
using the recipe, in a production environment of the first workload, to return the corrupted data to the cleaned state.

18. The computer system of claim 17, wherein using the recipe to return the corrupted data to the cleaned state comprises: not moving the data associated with the first workload from the isolated sandbox, wherein the returning the corrupted data to the cleaned state comprises: removing dormant malware from the data associated with the first workload and/or recovering uncorrupted data from a backup source.

19. The computer system of claim 17, wherein the operations further comprise:
storing the remediation steps as the recipe;
causing the recipe to leave the isolated sandbox; and
in response to a determination that the recipe has left the isolated sandbox: performing a cleanup on the isolated sandbox, and performing a teardown on the isolated sandbox.

20. The computer system of claim 17, wherein the operations further comprise:
creating a cryptographic signature for the recipe to prevent tampering with the recipe,
wherein the cryptographic signature is created before the recipe is caused to leave the isolated sandbox.
